(19) United States
(12) Patent Application Publication
(10) Pub. No.: US 2011/0084645 A1
(43) Pub. Date: Apr. 14, 2011

(54) POWER SUPPLY DEVICE AND DRIVING METHOD THEREOF

(75) Inventor: Kwang-youn SEO, Gyeonggi-do (KR)

(73) Assignee: SAMSUNG ELECTRONICS CO., LTD., Gyeonggi-Do (KR)

(21) Appl. No.: 12/900,558

(22) Filed: Oct. 8, 2010

(30) Foreign Application Priority Data
Oct. 13, 2009 (KR) 10-2009-0097371

(51) Int. Cl. H02J 7/00

(52) U.S. Cl. 320/101

(57) ABSTRACT

A power supply device and a driving method thereof which produces and supplies electric energy from ecology-friendly “green” energy sources. The power supply device collects green energy and supplies power to a load, and includes: a main power source unit that includes a collection unit for collecting green energy and generate electric energy therefrom, a converter which converts the electric energy from the collection unit into a predetermined electric energy level and a battery unit that stores the electric energy converted by the converter and supplies power to the load; and an auxiliary power source unit that supports the main power source unit and supplies power to the load. Maximum energy may be collected from green energy sources and generate maximum amounts of electric energy.

### CLAIM OF PRIORITY

This application claims priority from Korean Patent Application No. 10-2009-0097371, filed on Oct. 13, 2009 in the Korean Intellectual Property Office, the disclosure of which is incorporated herein by reference in its entirety.

### BACKGROUND OF THE INVENTION

1. Field of the Invention

The present invention relates to a power supply device and a driving method thereof. More particularly, the present invention relates to a power supply device and a driving method for use with environmentally friendly (ecology-friendly “eco-friendly” also referred to as “green”) sources.

2. Description of the Related Art

As exhaustion of natural resources and environmental and safety issues of thermal and nuclear power generation arise, research on eco-friendly green energy such as sunlight and wind is actively being carried out. Green energy is drawing much attention since it is endless supply and clean energy, and used in various areas including, without limitation to, unmanned lighthouse, clock tower and communication devices which are far away from power utility lines for power supplying as well as automobiles, toys, street lights and power generation for households. In the case of sunlight, solar energy may be converted into electric energy by a solar cell, which generates electricity with P-type semiconductors and N-type semiconductors. In other words, if the solar cell receives light, electrons and holes are formed, and electric charges move to the P and N poles, causing a potential difference between the P and N poles. If energy is collected from sunlight or wind, the collected energy gradually increases from an output voltage to a predetermined voltage and an output power exceeding the predetermined voltage gradually decreases. Such characteristic varies depending on the type of solar cells collecting green energy, seasonal change, temperatures and change of insolation. Accordingly, if electric energy is generated from green energy such as sunlight, wind, or terrestrial heat, the generated electric energy may have different levels of output power depending on the time of collection. If it is difficult to consistently store the electric energy generated from green energy and thus the stored electric energy is continuously supplied to a load, other energy which the load requires may not be supplied.

### SUMMARY OF THE INVENTION

Accordingly, one or more exemplary embodiments of the present invention provide a power supply device and a driving method thereof which generates a maximum amount of energy when producing electric energy from eco-friendly green energy such as sunlight or wind.

Further, one or more exemplary embodiments of the present invention provides a power supply device and a driving method thereof which stores generated electric energy and stably supplies energy needed by a load.

The foregoing and/or other exemplary aspects of the present invention may be achieved by providing a power supply device which collects green energy and supplies power to a load, the power supply device, which may include: a main power source unit which includes a collection unit for collecting green energy and generating electricity therefrom, a converter which converts the electric energy supplied by the collection unit into a predetermined electric energy level and a battery unit which stores the electric energy converted by the converter and supplies power to the load; and an auxiliary power source unit which supports the main power source unit and supplies power to the load.

According to an exemplary aspect of the present invention, the converter may supply the electric energy to the battery unit if the electric energy generated by the collection unit is within a predetermined error range based on a maximum level of electric energy to be generated by the collection unit.

According to another exemplary aspect of the present invention, the converter may include a sensor which detects a voltage of the collection unit, a reference voltage supply which supplies a reference voltage, and a first controller which compares the voltage of the collection unit detected by the sensor and the reference voltage supplied by the reference voltage supply and controls whether to store in the battery unit the electric energy generated by the collection unit.

According to yet another exemplary aspect of the present invention, the power supply device may further include a first switch which connects the main power source unit and the load, and a second controller which compares the voltage of the main power source unit and a preset first voltage and opens/closes the first switch.

The second controller may close the first switch if the voltage of the main power source unit is higher than the preset first voltage, and may open the first switch if the voltage of the main power source unit is lower than the preset first voltage.

According to yet another exemplary aspect of the present invention, the power supply device may further include a second switch which connects the auxiliary power source unit and the load, and a third controller which compares the voltage of the main power source unit and a preset second voltage and opens/closes the second switch.

The third controller may open the second switch if the voltage of the main power source unit is higher than the preset second voltage, and may close the second switch if the voltage of the main power source unit is lower than the preset second voltage.

The auxiliary power source unit may preferably include at least one of a battery and an adaptor.

The auxiliary power source unit may further preferably include a charging unit which receives electric power from the main power source unit to charge the battery if the auxiliary power source unit comprises the battery.

The power supply device may further include a fourth controller that controls an operation of the charging unit.

The fourth controller may operate the charging unit if the voltage of the main power source unit is higher than a preset third voltage, and may suspend the operation of the charging unit if the voltage of the battery is higher than a preset fourth voltage.

The above and other exemplary aspects of the present invention may achieved by providing a driving method of a power source device which collects green energy and supplies power to a load, the driving method including: collecting green energy to generate electric energy and converting the electric energy into a predetermined electric energy level to store the energy; supplying the stored electric energy to the load; and supporting the stored electric energy and supplying auxiliary energy to the load.

According to yet another exemplary aspect of the present invention, a power supply device may store the generated electric energy if the generated electric energy is within a predetermined error range based on a maximum level of electric energy to be generated by the power supply device.

According to another exemplary aspect of the present invention, the power supply device may supply the stored electric energy to the load if a voltage of the stored electric energy is higher than a preset first voltage, and suspends supply of the stored electric energy to the load if the voltage of the stored electric energy is lower than the first voltage.

According to yet another exemplary aspect of the present invention, the power supply device may supply the auxiliary energy to the load if the voltage of the stored electric energy is lower than a preset second voltage, and suspends supply of the stored auxiliary energy to the load if the voltage of the stored electric energy is higher than the preset second voltage.

The power supply device may preferably supply the auxiliary energy to the load by using an adaptor.

The power supply device may preferably charge a battery by supplying the stored electric energy to the battery and uses the energy charged to the battery as the auxiliary energy.

The power supply device may preferably charge the battery if the voltage of the stored electric energy is higher than a preset third voltage, and suspends the charging of the battery if the voltage of the battery is higher than a preset fourth voltage.

### BRIEF DESCRIPTION OF THE DRAWINGS

The above and/or other exemplary aspects of the present invention will become more apparent to and more readily appreciated by a person of ordinary skill in the art from the following description of the exemplary embodiments, taken in conjunction with the accompanying drawings, in which:

FIG. 1 is a block diagram of a power supply device according to an exemplary embodiment of the present invention;

FIG. 2 is a graphical illustration of a characteristic of a capacitor used in the power supply device according to the exemplary embodiment of the present invention;

FIG. 3 illustrates a capacitance of a capacitor used in the power supply device according to the exemplary embodiment of the present invention;

FIG. 4 illustrates a characteristic of collected energy if the power supply device according to the exemplary embodiment of the present invention collects green energy;

FIG. 5 is a circuit diagram to illustrate an operation of an maximum power point tracking (MPPT) of the power supply device according to the exemplary embodiment of the present invention;

FIG. 6 is a circuit diagram to illustrate an operation of the power supply device according to the exemplary embodiment of the present invention; and

FIG. 7 is a flowchart of the operation of the power supply device according to an exemplary embodiment of the present invention.

### DETAILED DESCRIPTION

Herein below, exemplary embodiments the POWER SUPPLY DEVICE AND DRIVING METHOD THEREOF according to the present invention will be described in detail with reference to accompanying drawings so as to be easily realized by a person having ordinary skill in the art. The exemplary embodiments of the claimed invention may be embodied in various forms without being limited to the exemplary embodiments set forth herein. Descriptions of well-known functions and structures may be omitted for clarity when their inclusion might obscure appreciation of the present invention by a person of ordinary skill in the art, and like reference numerals refer to like elements throughout.

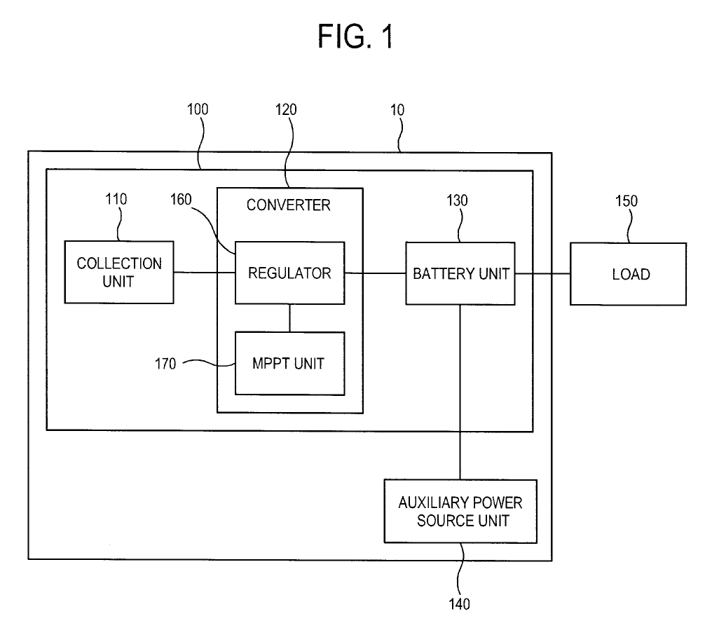

FIG. 1 is a block diagram of a power supply device 10 according to an exemplary embodiment of the present invention. As shown therein, the power supply device 10 according to the present invention preferably includes a main power source unit 100 and an auxiliary power source unit 140. The main power source unit 100 includes a collection unit 110, a converter 120 and a battery unit 130. The collection unit 110 collects energy from green energy sources to generate electric energy. The green energy sources preferably include solar heat, wind, and terrestrial heat. If the collection unit 110 collects energy from solar heat, it may include a solar cell. The converter 120 may include a regulator 160 and a maximum power point tracking (MPPT) unit 170. If electric energy is generated from a green energy source (or sources), the regulator 160 converts the generated electric energy into predetermined electric energy (e.g. a regulated voltage level) to be stored in the battery unit 130. The regulator 160 may include a boost regulator. The MPPT unit 170 controls the time of collecting green energy to produce a maximum amount of electric energy collected by the collection unit 110. The battery unit 130, which stores generated electric energy, may include a capacitor as a storage device. The auxiliary power source unit 140 supplies electric energy to a load 150 by supporting the main power source unit 110. The auxiliary power source unit 140 may preferably include a battery or adaptor.

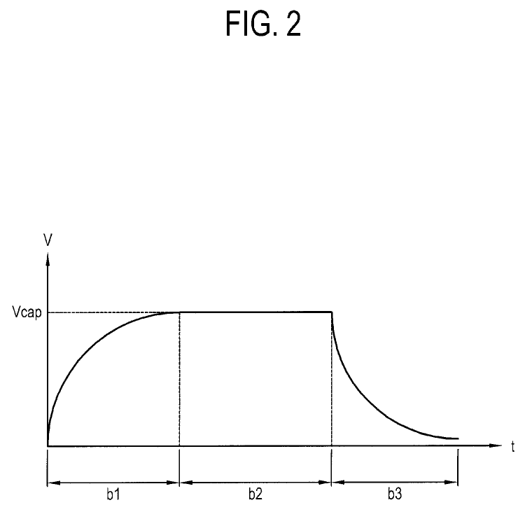

FIG. 2 is a graphical illustration of a characteristic of the capacitor used in the power supply device 10 according to the exemplary embodiment of the present invention. Upon supply of electric energy, the capacitor is charged during a charging time “b1” and a voltage level of the capacitor rises. If the voltage reaches a saturation voltage Vcap, the capacitor maintains the saturation voltage Vcap and is not charged any further even if the electric energy is continuously supplied as the storage capacity is full. If the capacitor is discharged, the stored energy is discharged during a discharging time “b3”.

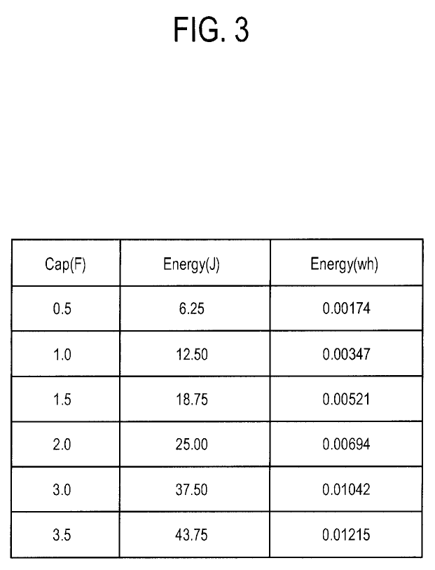

FIG. 3 illustrates a capacitance (in Farads) of some exemplary capacitors that can be used in the power supply device 10 according to the exemplary embodiment of the present invention. 1 wh equals energy supplied for one hour with respect to 1 w. That is, 0.00347 wh means continuous supply of energy of 0.0037 J for one hour. If the battery unit 130 uses the capacitor, it determines the capacitance of the capacitor to efficiently supply electric energy needed by the load 150. If the capacitance of the capacitor is too small compared to the electric energy needed by the load 150, the electric energy may not be supplied sufficiently. In addition, if the capacitance of the capacitor is too large, energy efficiency may be reduced.

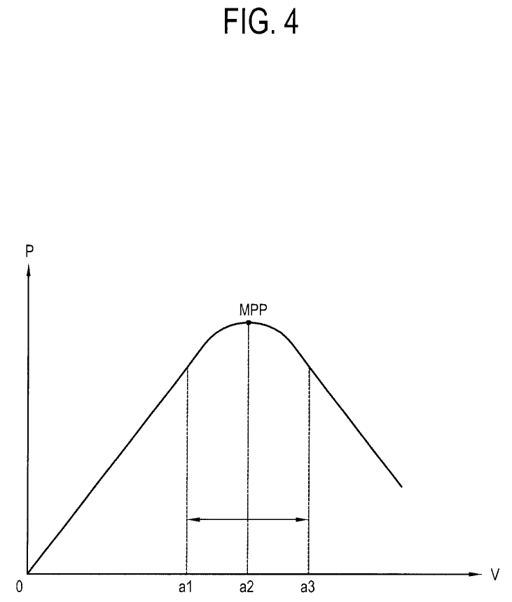

FIG. 4 illustrates a characteristic of collected energy when the power supply device 10 according to the exemplary embodiment of the present invention collects energy from a green energy source. As shown therein, if electric energy is generated from a green energy source, an output power of the generated electric energy is indicated as a curved line. That is, output power gradually increases when an output voltage of the generated electric energy ranges from 0v to a predetermined voltage a2. If the output voltage exceeds the predetermined voltage a2, the output power gradually decreases. At the predetermined voltage a2, the output power is equal to the maximum power of the electric energy generated from the green energy source(s), at which point the predetermined voltage a2 is called a maximum power point (MPP) of the green energy generated the maximum electric energy from green energy, electric energy generated at the voltage a2 representing the maximum power point should be stored. However, it is difficult to store the electric energy accurately at the voltage a2 representing the MPP. Thus, the electric energy that is generated when the voltage a2 is within a predetermined error range is stored. In FIG. 4, a subordinate voltage a1 and a superior voltage a3 are within a predetermined error range based on the voltage a2 representing the maximum voltage point wherein the maximum voltage point is also the MPP. The power supply device 10 according to the present exemplary embodiment measures the voltage of the electric energy generated from the green energy source(s), and converts the generated electric energy and stores the energy in the battery unit 130 if the voltage ranges between the subordinate voltage a1 and the superior voltage a3. In other cases, the power supply device 10 according to the present exemplary embodiment does not store the generated electric energy. The superior voltage a2 and the subordinate voltage a1 may be set in advance depending on the type of green energy source(s).

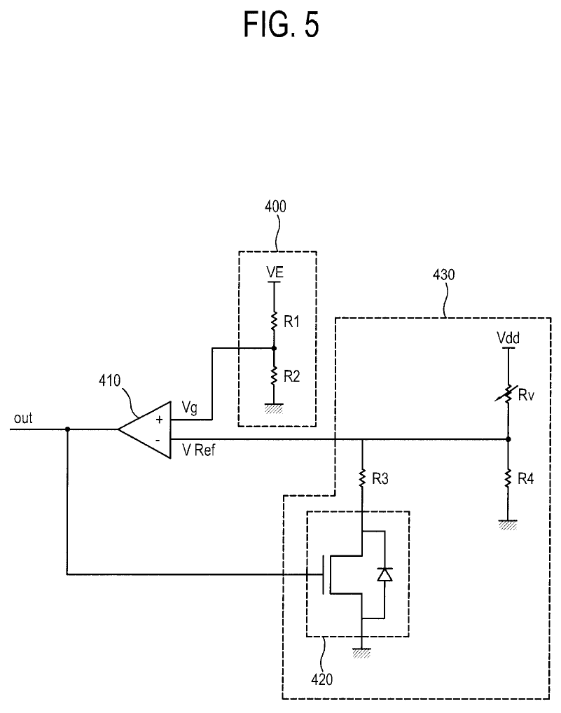

FIG. 5 illustrates a circuit diagram of the MPPT unit of the power supply device 10 according to the exemplary embodiment of the present invention. The MPPT unit 170 may preferably include a sensor 400 that detects a voltage of electric energy generated from a green energy source, a reference voltage supply 430 which supplies a reference voltage, and a first controller 410 that compares a voltage detected by the sensor 400, and a reference voltage supplied by the reference voltage supply 430 and controls whether to store the generated electric energy in the battery unit 130. The reference voltage supply 430 supplies a superior voltage a3 and a subordinate voltage a1 which are within a predetermined error range based on the value of voltage a2 from a maximum power point MPP outputting maximum power. The reference voltage supply 430 may include a variable resistor Rv, fixed resistors R3 and R4, and a switch 420. The switch 420 may preferably include a MOSFET and a diode.

Referring now to the operation of the MPPT unit 170 shown in FIG. 1, if the superior voltage a3 and subordinate voltage a1 are determined, the MPPT unit 170 adjusts the variable resistor Rv and supplies the superior voltage a3 to the first controller 410. The first controller 410 may include a comparator. A (+) terminal of the comparator receives a voltage of electric energy Vg generated from the green energy detected by the sensor 400 while a (−) terminal receives a reference voltage Vref from the reference voltage supply 430. If the reference voltage Vref from supply 430 supplies the superior voltage a3, the first controller 410 compares the voltage Vg supplied by the sensor 400 and the superior voltage a3. If the voltage of the generated electric energy Vg is larger than the superior voltage a3, the first controller 410 outputs a high signal to the regulator 160 to convert the electric energy generated by the collection unit 110 into a specific electric energy level and store the electric energy in the battery unit 130.

The output of first controller 410 is also supplied as a high signal to the switch 420 of the reference voltage supply 430. If the switch 420 is turned off, the resistors R3 and R4 do not affect each other. However, if the switch 420 is turned on, the resistors R3 and R4 are connected in parallel. If the resistors R3 and R4 are connected in parallel, a total resistance value after the connection becomes smaller than that of the resistor R4 (due to the total resistance value=(R3×R4)/(R3+R4). Thus, the superior voltage a3 is changed to the subordinate voltage a1. The resistance value of the resistors R3 and R4 may be set in consideration of the size of the superior voltage a3 and subordinate voltage a1. If the reference voltage is changed to the subordinate voltage a1, the first controller 410 may supply a high signal to the regulator 160 and the switch 420 until the voltage supplied by the sensor 400 is smaller than the subordinate voltage a1. If the voltage supplied by the sensor 400 becomes smaller than the subordinate voltage a1, the first controller 410 supplies a low signal to the regulator 160 so as not to store in the battery unit 130 the electric energy generated from the collected green energy. As the low signal is supplied to the switch 420, the switch 420 is turned off and the reference voltage rises to the superior voltage a3 again. Then, if the voltage Vg of the electric energy generated from the green energy source ranges between the subordinate voltage a1 and the superior voltage a3, the power supply device 10 according to the present exemplary embodiment may store in the battery unit 130 the electric energy generated from the collected green energy source.

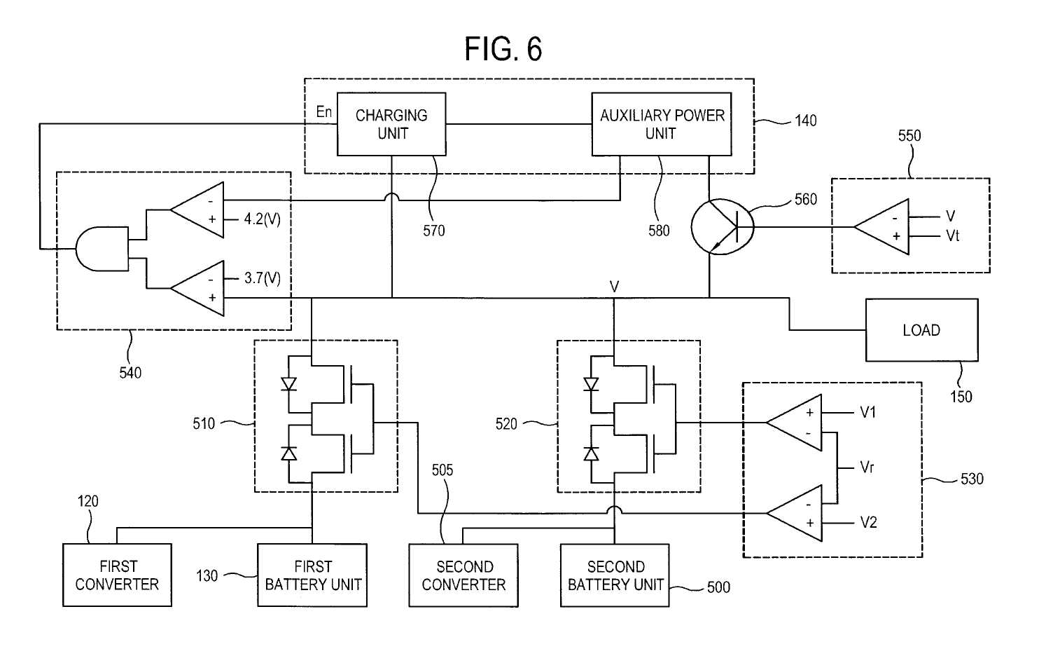

FIG. 6 is a circuit diagram of an operation of the power supply device 10 according to the exemplary embodiment of the present invention. The power supply device 10 according to the present exemplary embodiment may collect energy from solar heat, wind and terrestrial heat, as few of the possible examples of green energy sources used to supply electric energy. If electric energy is generated from a plurality of energy sources, there may exist a plurality of main power units which generates electric energy from green energy sources and stores the electric energy.

As shown in FIG. 6, the first battery unit 130 and a second battery unit 500 receives electric energy from the first converter 120 and a second converter 505, respectively, and are connected to the load 150 through first and second switches 510 and 520. The second controller 530 controls the first and second switches 510 and 520, which preferably includes a MOSFET and a diode. If electric energy, which is generated from sunlight, is stored in the first battery unit 130, the second controller 530 closes the first switch 510 and supplies electric energy from the first battery unit 130 to the load 150 if a voltage V1 of the electric energy stored in the first battery unit 130 is higher than a specific voltage Vr. If electric energy, which is generated from wind, is stored in the second battery unit 500, the second controller 530 closes the second switch 520 and supplies electric power to the load 150 if a voltage V2 of the electric energy stored in the second battery unit 500 is equal to a specific voltage Vr or higher. The second controller 530 may control the first and second switches 510 and 520 by setting different specific voltages Vr to supply the electric energy to the load 150 from the first and second battery units 130 and 500. The second controller 530 may include a comparator to compare the voltage of the first and second battery units 130 and 500 and the specific voltage Vr.

With continued reference to FIG. 6, the power supply device 10 according to the present exemplary embodiment may store in the auxiliary power source unit 140 the electric energy generated by the main power source unit 100. The auxiliary power source unit 140 may preferably include a battery or adaptor for use as an auxiliary power unit 580. The adaptor receives electric energy from the outside and does not need to be charged when the battery is charged. If the auxiliary power unit 580 includes a battery, the auxiliary power source unit 140 may include a charging unit 570 to charge the battery. The battery may be charged if a predetermined voltage or higher is supplied. Accordingly, if the voltage of the electric energy stored in the main power source unit 100 is the predetermined voltage or higher, the third controller 540 supplies the electric energy stored in the main power source unit 100 to the auxiliary power source unit 140 and charges the battery. For example, the battery may be charged from a value of 3.7 volts or higher. If the voltage of the battery is 4.2v in the case when the battery is completely charged, the third controller 540 supplies a high signal to the charging unit 570 and charges the battery when the voltage of the main power source unit 100 is 3.7v or higher. If the battery is completely charged and the voltage is 4.2v, the third controller 540 supplies a low signal to the charging unit 570 and stops the charging unit 570 from charging the battery. The third controller 540 may include two comparators and an AND gate.

With continued reference to FIG. 1, if the main power source unit 100 supplies energy to the load 150, it may not supply sufficient electric power needed by the load 150. In other words, even though the load 150 needs a predetermined voltage at the minimum, if the main power source unit 100 continues to supply electric energy, the stored electric energy gradually decreases and the voltage of the electric energy stored in the main power source unit 100 does not reach the voltage level of the load 150. In this case, the auxiliary power source unit 140 supports the main power source unit 100 and supplies electric energy to the load 150. Referring to the process of supplying electric energy from the auxiliary power source unit 140 to the load 150, the auxiliary power source unit 140 is connected to the load 150 through the third switch 560 (FIG. 6), and the fourth controller 550 controls the third switch 560. The third switch may preferably include, for example, a bipolar junction transistor (BJT). The fourth controller 550 closes the third switch 560 and controls the auxiliary power source unit 140 to supply electric energy to the load 150 if the voltage V of the electric energy stored in the main power source unit 100 is smaller than the minimum voltage Vt to be used by the load 150. The voltage Vt may be the same as the voltage Vr. The fourth controller 550 may compare the voltage V of the electric energy stored in the main power source unit 100 and the minimum voltage Vt to be used by the load 150 by using the comparator. If there exists a plurality of main power source units 100, the voltage V of the electric energy stored in the main power source unit 100 compared by the fourth controller 550 may be the sum of voltage of all main power source units 100.

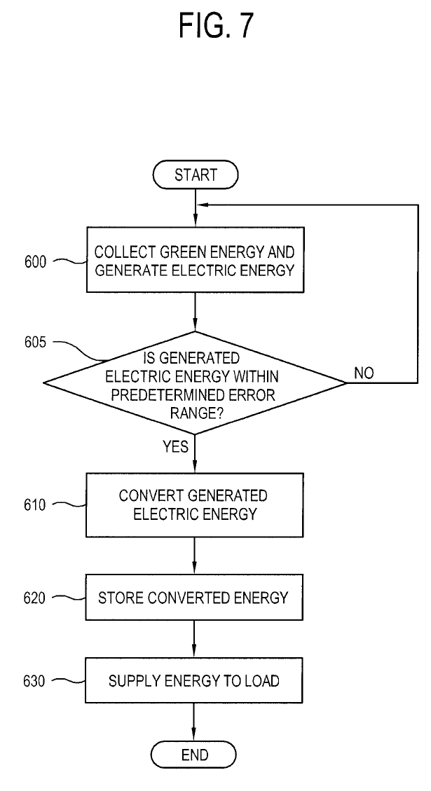

FIG. 7 is a flowchart illustrating an example of operation of the power supply device 10 according to the exemplary embodiment of the present invention such as shown in FIG. 1.

At (S600), green energy is collected by the collection unit 110 to generate electric energy, and at (S605) if the electric energy generated by the collection unit 110 is within the predetermined error range based on the maximum level of the electric energy to be collected and generated by the collection unit 110, then at (S610) the converter 120 converts the generated electric energy into the predetermined electric energy level and (S620) stores the converted electric energy in the battery unit 130. However, if at (S605) the electric energy collected and generated by the collection unit 110 is not within the predetermined error range, the collection unit 110 continues to collect green energy. If the generated electric energy is converted by the converter 120 and stored in the battery unit 130, then at (S630) the load 150 may be connected to the battery unit 130 and receive power. The electric energy stored in the battery unit 130 may be charged by the auxiliary power source unit 140. If the main power source unit 100 does not supply sufficient electric energy, the auxiliary power source unit 140 may supply electric energy to the load 150.

As described above, a power supply device and a driving method thereof according to the present invention may collect maximum energy from green energy sources and generate maximum electric energy.

Further, the power supply device and the driving method thereof according to the present invention may store collected energy in main and auxiliary energy sources and stably supply energy needed by a load.

Although a few exemplary embodiments of the presently claimed invention have been shown and described herein, it will be appreciated by those skilled in the art that changes may be made in these exemplary embodiments without departing from the principles and spirit of the invention, the scope of which is defined in the appended claims and their equivalents.

What is claimed is:

1. A power supply device that collects energy from a green energy source and supplies power to a load, said power supply device comprising:
a main power source unit including:
a collection unit for collecting energy from a green energy source and generating electric energy therefrom,
a converter for converting the electric energy supplied by the collection unit into a predetermined electric energy level,
a battery unit which stores the electric energy converted by the converter and supplies power to the load; and
an auxiliary power source unit that supports the main power source unit that supplies auxiliary power to the load,
wherein the green energy source from which the collection unit collects green energy includes at least one of solar heat, wind, and terrestrial heat.

2. The power supply device according to claim 1, wherein the converter supplies the electric energy to the battery unit when the electric energy generated by the collection unit is within a predetermined error range based on a maximum level of electric energy to be generated by the collection unit.

3. The power supply device according to claim 1, wherein the converter comprises a sensor which detects a voltage level of electric energy generated in the collection unit, a reference voltage supply which supplies a reference voltage, and a first controller which compares the voltage of electric energy generated in the collection unit detected by the sensor with the reference voltage supplied by the reference voltage supply and determines whether or not to store the electric energy generated by the collection unit in the battery unit based on a result of the comparison.

4. The power supply device according to claim 1, further comprising a first switch that connects the main power source unit and the load; and a second controller which compares a voltage level of the main power source unit with a preset first voltage and opens/closes the first switch based on a result of the comparison.

5. The power supply device according to claim 4, wherein the second controller closes the first switch when the voltage of the main power source unit is higher than the preset first voltage, and opens the first switch when the voltage of the main power source unit is lower than the preset first voltage.

6. The power supply device according to claim 1, further comprising a switch that connects the auxiliary power source unit and the load; and a controller that compares the voltage of the main power source unit and a preset second voltage and opens/closes the switch.

7. The power supply device according to claim 6, wherein the controller opens the switch when the voltage of the main power source unit is higher than the preset second voltage, and closes the switch when the voltage of the main power source unit is lower than the preset second voltage.

8. The power supply device according to claim 1, wherein the auxiliary power source unit comprises at least one of a battery and an adaptor.

9. The power supply device according to claim 8, wherein the auxiliary power source unit comprises the battery, said power supply device further comprises a charging unit which receives electric power from the main power source unit for charging the battery.

10. The power supply device according to claim 9, further comprising a controller which controls an operation of the charging unit.

11. The power supply device according to claim 10, wherein the controller operates the charging unit when the voltage of the main power source unit is higher than a minimum preset voltage, and suspends the operation of the charging unit if the voltage of the battery is higher than a maximum preset voltage.

12. A driving method of a power source device which collects green energy comprising at least one of solar heat, wind, and terrestrial heat and supplies power to a load, the driving method comprising:
collecting green energy from a green energy source to generate electric energy and converting the electric energy into a predetermined electric energy level to store the energy;
supplying the stored electric energy to the load; and
supporting the stored electric energy and supplying auxiliary energy to the load when auxiliary energy is required to be supplied to the load.

13. The driving method according to claim 12, wherein the power supply device stores the generated electric energy when the generated electric energy is within a predetermined error range based on a maximum level of electric energy to be generated by the power supply device.

14. The driving method according to claim 12, wherein the power supply device supplies the stored electric energy to the load when a voltage of the stored electric energy is higher than a preset first voltage, and suspends supply of the stored electric energy to the load if the voltage of the stored electric energy is lower than the preset first voltage.

15. The driving method according to claim 12, wherein the power supply device supplies the auxiliary energy to the load when the voltage of the stored electric energy is lower than a threshold voltage, and suspends supply of the stored auxiliary energy to the load when the voltage of the stored electric energy is higher than the threshold voltage.

16. The driving method according to claim 12, wherein the power supply device supplies the auxiliary energy to the load by using an adaptor.

17. The driving method according to claim 12, wherein the power supply device charges a battery by supplying the stored electric energy to the battery and uses the energy charged to the battery as the auxiliary energy.

18. The driving method according to claim 17, wherein the power supply device charges the battery when the voltage of the stored electric energy is higher than a particular minimum voltage, and suspends the charging of the battery when the voltage of the battery is higher than a particular maximum voltage.
